(19) United States
(12) Patent Application Publication
(10) Pub. No.: US 2010/0110069 A1
(43) Pub. Date: May 6, 2010

(54) System for rendering virtual see-through scenes

(75) Inventor: Chang Yuan, Vancouver, WA (US)

Correspondence Address: KEVIN L. RUSSELL;CHERNOFF, VILHAUER, MCCLUNG & STENZEL LLP, 1600 ODSTOWER, 601 SW SECOND AVENUE, PORTLAND, OR, 97204, US

(73) Assignee: Sharp Laboratories of America, Inc.

(21) Appl. No.: 12/290,585

(22) Filed: Oct. 31, 2008

(51) Int. Cl. G06T 15/20

(52) U.S. Cl. 345/419

(57) ABSTRACT

A system for displaying an image on a display includes a display for displaying an image thereon. A three dimensional representation of an image is obtained. The three dimensional representation is rendered as a two dimensional representation on the display. An imaging device is associated with the display. The location of a viewer is determined with respect to the display. The rendering on the display is based upon the determining the location of the viewer with respect to the display.

### CROSS-REFERENCE TO RELATED APPLICATIONS

Not applicable.

### BACKGROUND OF THE INVENTION

The present invention relates to displaying images on a display.

Flat panel display systems have become increasingly popular in recent years, due to their relatively high image qualities, relatively low power consumption, relatively large available panel sizes, and relatively thin form factors. A single flat panel can reach as large as 108 inches or greater diagonally, although they tend to be relatively expensive compared to smaller displays. Meanwhile, an array of relatively less expensive smaller panels can be integrated together to form a tiled display, where a single image is displayed across the displays. Such tiled displays utilize multiple flat panels, especially liquid crystal display (LCD) panels, to render the visual media in ultra-high image resolution together with a wider field of view than a single panel making up the tiled display.

Conventional display technologies, however, can only render visual media as if it was physically attached to the panels. In this manner, the image is statically displayed on the single or tiled panels, and appears identical independent of the position of the viewer. The “flat” appearance on a single or tiled panel does not provide viewers with a strong sense of depth and immersion. Furthermore, if the panel is moved or rotated, the image rendered on that panel is distorted with respect to a viewer that remains stationary, which deteriorates the visual quality of the display.

Stereoscopic display devices are able to render three dimensional content in binocular views. However, such stereoscopic displays usually require viewers either to wear glasses or to stay in certain positions in order to gain the sense of three dimensional depth. Furthermore, the image resolution and refresh rate are generally limited on stereoscopic displays. Also, stereoscopic display devices need to be provided with true three dimensional content, which is cumbersome to generate.

Another three dimensional technique is for viewers to wear head-mounted displays (HMD) to view the virtual scene. Head-mounted displays are limited by their low image resolution, binocular distortion, complex maintenance, and physical intrusion of special glasses and associated displays.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates an overall pipeline of a rendering technique.

FIG. 2 illustrates an overview of a virtual scene process.

FIG. 3 illustrates creating a 3D virtual scene.

FIGS. 4A and 4B illustrate building a 3D virtual scene from 2D media.

FIGS. 5A-5D illustrate choosing focus point for single and multiple viewers.

FIG. 6 illustrates transforming a virtual scene so as to be placed behind the display.

FIG. 7 illustrates a viewer tracking process.

FIGS. 8A and 8B illustrate a ray tracking process based on a changed focus point.

FIG. 9 illustrates a ray tracking process for each pixel on the panels.

FIG. 10 illustrates a representation of tracking results by different cameras and markers.

FIG. 11 illustrates a flexible viewer tracking technique.

FIG. 12 illustrates an overview of a scene rendering process.

FIG. 13 illustrates a top view of a viewing point and a look at point.

FIG. 14 illustrates a single rendering GPU and a single/tiled display.

FIG. 15 illustrates a single rendering GPU and a single/tiled display.

FIG. 16 illustrates a rendering GPU cluster and a single/tiled display.

FIG. 17 illustrates several rendering GPU clusters and a single/tiled display.

FIG. 18 illustrates a process pipeline for a rendering GPU cluster and a tiled display.

FIG. 19 illustrates a rendering GPU cluster and a tiled display.

FIG. 20 illustrates an overview of the panel process.

FIGS. 21A-21C illustrate different geometric shapes for a tiled display.

FIG. 22 illustrates rending wide screen content on a curved tiled display.

FIGS. 23A and 23B illustrate tiled display fitted within a room.

FIG. 24 illustrates geometric shape calibration for the tiled display.

FIG. 25 illustrates calibration of display parameters for the tiled display.

### DETAILED DESCRIPTION OF PREFERRED EMBODIMENT

As opposed to having an image that is statically displayed on a panel, it is desirable to render the visual media in a virtual scene behind the flat panels, so that the viewers feel they are seeing the scene through the panels. In this manner, the visual media is separated from the flat panels. The display system acts as “French windows” to the outside virtual scene, leading to a so called “see-through” experience.

Although the display system inherently renders only two dimensional views, the viewers can still gain a strong sense of immersion and the see-through experience. When the viewer moves, he/she may observe the scene move in the opposite direction, varying image perspectives, or even different parts of the scene. The viewer can observe new parts of the scene which were previous occluded by the boundary of virtual windows. If there are multiple depth layers in the scene, the viewers also observe 2D motion parallax effects that bring additional sense of depth to them.

In order to generate the “see-through” experience, the display system may create and render a virtual scene behind the panels. If the original visual media is two dimensional, it can be converted to three dimensional structures. The 3D visual media is then transformed to a 3D space behind the panels, thereby creating a virtual scene to be observed by viewers. The rendering of the scene on the display is modified based upon the viewers' position, head position and/or eye positions (e.g., locations), as the viewers may move freely in front of the display. In order to determine the position of the viewer, one or more cameras (or any sensing devices) may be mounted to the panel, or otherwise integrated with the panel, to track the viewers' position, head, and/or eyes in real time. The imaging system may further track the location of the gaze of the viewer with respect to the panel. A set of virtual 3D optical rays are assumed to be projected from the virtual scene and converge at the viewers' position and/or head and/or eye position(s). The motion of the viewer may also be tracked. The image pixels rendered on the panels are the projection of these optical rays onto the panels. The color for each pixel on the panels is computed by tracing the optical rays back into the virtual scene and sampling colors from the virtual scene.

Since the virtual scene with different depth layers is separated from the panels, the configuration of the panels is flexible, including geometric shapes and display parameters (e.g. brightness and color). For example, the position, the orientation, and the display parameters of each panel or “window” may be changed independently of one another. In order to generate a consistent experience of seeing through the flat panel surfaces, the system should automatically calibrate the panels and modify parameters. This technique may use a camera placed in front of the display to capture the images displayed on the panels. Then the 3D position, the orientation, the display settings, and the color correction parameters may be computed for each panel. Thereafter, the rendered images are modified so that the rendered views of the virtual scene remain consistent across the panels. This calibration process may be repeated when the panel configuration is changed.

A technique for providing a dynamic 3D experience, together with modification based upon the viewer's location, facilitates a system suitable for a broad range of applications. One such application is to generate an “adaptive scenic window” experience, namely, rendering an immersive scenic environment that surrounds the viewers and changes according to the viewers' motion. The display system may cover an entire wall, wrap around a corner, or even cover a majority of the walls of an enclosed room to bring the viewers a strong sense of immersion and 3D depth. Another application is to compensate for the vibration of display devices in a dynamic viewing environment, such as buses and airplanes. As the viewers and display devices are under continuous vibrations in these environments, the visual media rendered on the display may make the viewers feel discomfort or even motion sickness. With real-time viewer tracking and see-through rendering functionalities, the visual media may be rendered virtually behind the screen with a synthetic motion synchronized with the vibration, which would then appear stabilized to the viewer. The discomfort in watching vibrating displays is thus reduced.

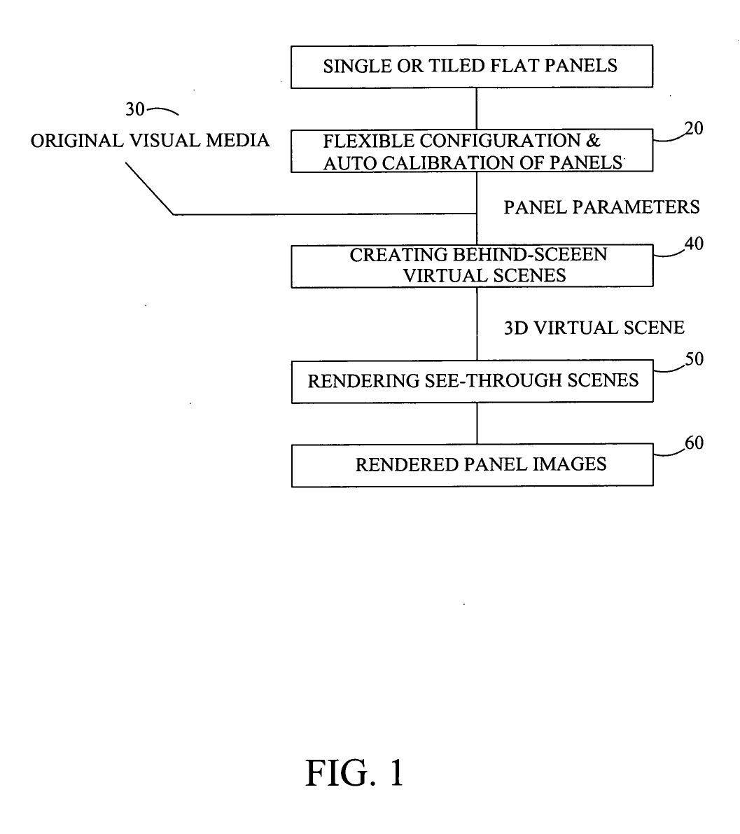

The overall pipeline of the technique is illustrated in FIG. 1. It starts by an optional step of flexible configuration and automatic calibration of panels 20. The configuration and calibration step 20 can be omitted if the geometric shape and display parameters of flat panels are already known and do not need to be modified. Based on the calibration results 20, the original visual media (2D media may be converted to 3D structures) 30 is transformed for creating a virtual scene behind the panels 40. The see-through experience occurring at the display 60 is generated by rendering the virtual scene 50 according to the tracked locations of the viewer.

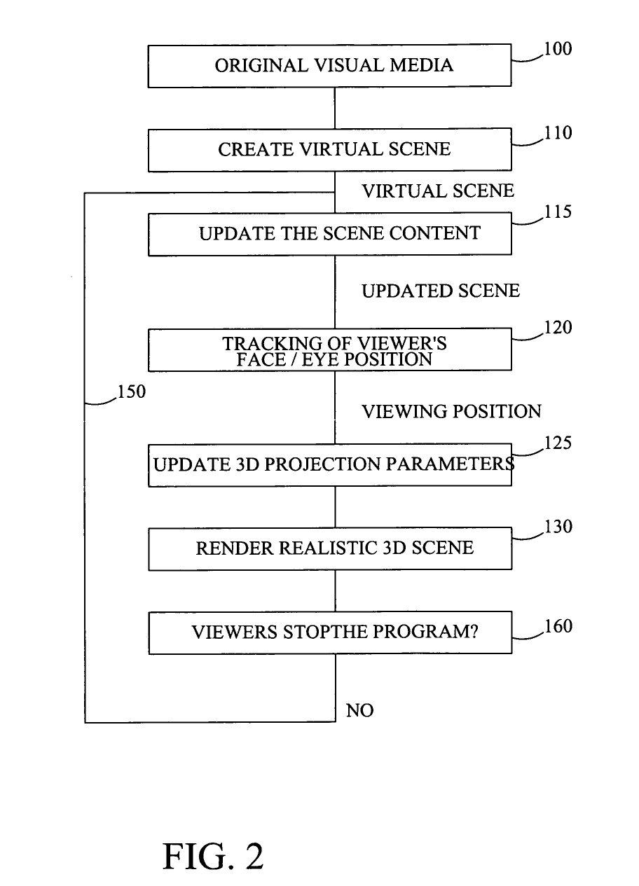

An exemplary process of creating and rendering the virtual see-through scenes on a single or tiled display is shown in FIG. 2. The original visual media 100 is transformed for creating a 3D virtual scene behind the panels 110. The scene content may be updated 115, if desired. Based on the tracked viewers' head positions 120 and/or the movement of the viewer, or other suitable criteria, the three dimension projection parameters may be updated 125. A ray tracing 130, or other suitable process, based rendering process computes the color for each pixel on the panels. When the viewers move, the tracked head positions (or otherwise) are updated 150 and the images displayed on the panels are changed accordingly in real time. This tracking and rendering process continues as long as there are viewers in front of the display system or until the viewer stops the program 160.

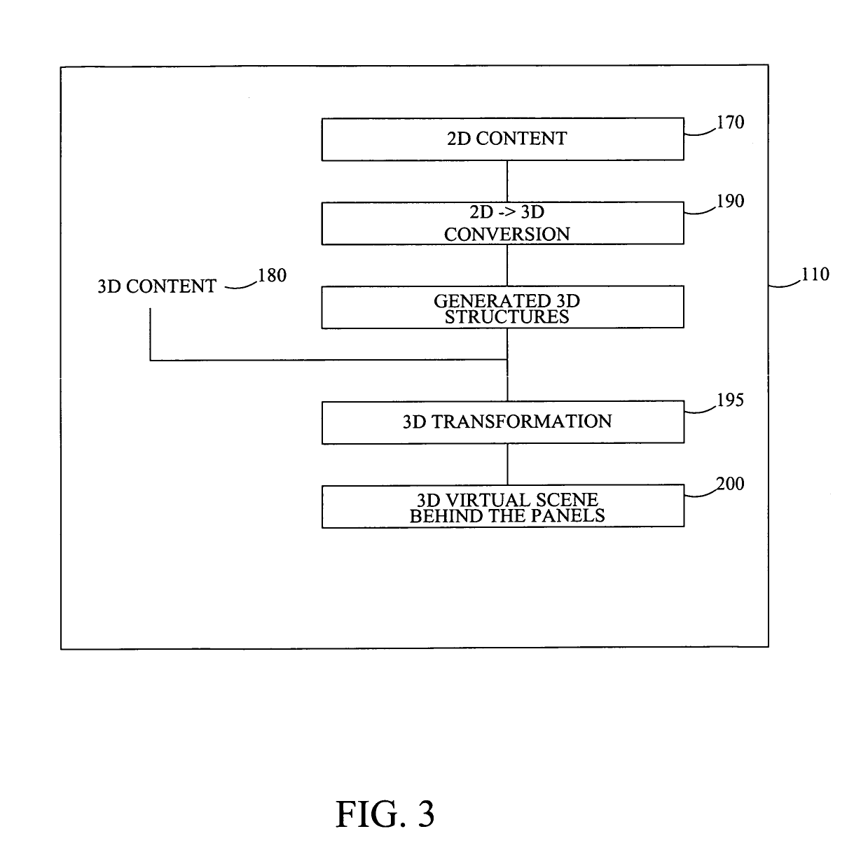

Referring to FIG. 3, in order to generate the see-through effect, a virtual scene may be created based on the original visual media, which may be 2D content 170 (images, videos, text, vector graphics, drawings, graphics, etc), 3D content 180 (graphics, scientific data, gaming environments, etc), or a combination thereof. As the 2D content does not inherently contain 3D information, a process 190 of converting 2D content into 3D structures may be used. Possible 3D structures include points, surfaces, solid objects, planar surfaces, cylindrical surfaces, spherical surfaces, surfaces described by parametric and/or non-parametric equations, and the like. Then the 3D structure and content may be further transformed 195 so that they lie in the field of view and appear consistent with real-life appearances. The transformation applied to the 3D structures includes, one or the combination of, 3D translation, rotation, and scaling. The process results in creating a 3D virtual scene behind the panels 200.

The 2D-to-3D conversion process 190 can be generally classified into two different categories. The first category is content independent. The 2D-to-3D conversion is implemented by attaching 2D content to pre-defined 3D structures without analyzing the specific content. The three dimensional structures may be defined by any mechanism, such as, vertices, edges, and normal vectors. The two dimensional content may, for example, serve as texture maps. For example, a 2D text window can be placed on a planar surface behind the panels. Another example is that a 2D panoramic photo with an extremely large horizontal size is preferably attached to a cylindrical 3D surface which simulates an immersive environment for viewers to observe. The cylindrical nature of the surface allows viewers to rotate their heads in front of the display and observe different parts of the panoramic image. Preferably, the image is sized to substantially cover the entire display. In this case, all the image content is distant from the viewers and has passed the range where stereo or occlusion effects can occur. These conversion steps are pre-defined for all kinds of 2D media and do not depend on the specific content.

The second category is content dependent. The 2D visual media is analyzed and converted to 3D by computer vision and graphics techniques. For example, a statistical model learned from a large set of images can be utilized to construct a rough 3D environment with different depth layers from a single 2D image. Another technique includes 3 dimensional volume rendering based on the color and texture information extracted from two dimensional content. For example, a large number of particles may be generated and animated independently to simulate fireworks. The colors of these particles may be sampled from the 2D content to generate a floating colorful figure in the sky. These embodiments enable fast conversion of 2D content into the 3D space and allow the viewers to obtain 3D depth sense with the traditional 2D content. There also exist semi-automatic 2D-to-3D conversion methods that combine automatic conversion techniques with human interaction.

Another technique to create a 3D image includes building a virtual scene based on 3D graphical models and animation parameters. The models may include, for example, 3D geometric shapes, color texture images, and GPU (graphics processing units) shader programs that generate the special effects including scattered lighting and fogs. The animation parameters define the movement of objects in the scene and shape deformation. For example, the virtual scene can depict a natural out-door environment, where there are sun light, trees, architectures and wind. Another example of 3D graphics scene is a man-made out-door scene based on an urban setting with buildings, streets, moving cars and walking humans. These models can be loaded by 3D rendering engines, e.g. OpenGL and DirectX, and rendered on one or more computers in real time.

Another technique to create a 3D image of the virtual scene is using a dynamic 3D scene that combines 2D and 3D content together with live-feed information content. The live-feed information content includes 2D images and video, 3D scene models, and other information depending on the current scene and viewing position. The live-feed content is stored in a database and is downloaded to the viewer's computer as needed. When the viewer moves in front of the display, he will observe different parts of the scene and varying information content is dynamically loaded into the scene. Examples of these dynamic scenes are the virtual world application Second Life, online 3D games, and 3D map applications like Google Earth.

Another technique to create a 3D image of the virtual scene is using a free viewpoint video based on an array of video cameras, sometimes referred to as free view-point video. The display is connected to an array of video cameras that are placed in a line, arc, or other arrangement directed at the same scene with different angles. The cameras may either be physically mounted on the display or remotely connected through a network. When the viewer moves to a new position in front of the display, a new view is generated by interpolating the multiple views from the camera array and is shown on the display screen.

The 3D virtual scene generated by any suitable technique may be further transformed 195 so that it lies in the field of view behind the display screen of the viewer and has a realistic and natural appearance to the viewers. The geometric models in the scene may be scaled, rotated, and translated in the 3D coordinate system so that they face the viewers in the front direction and lie behind the screen.

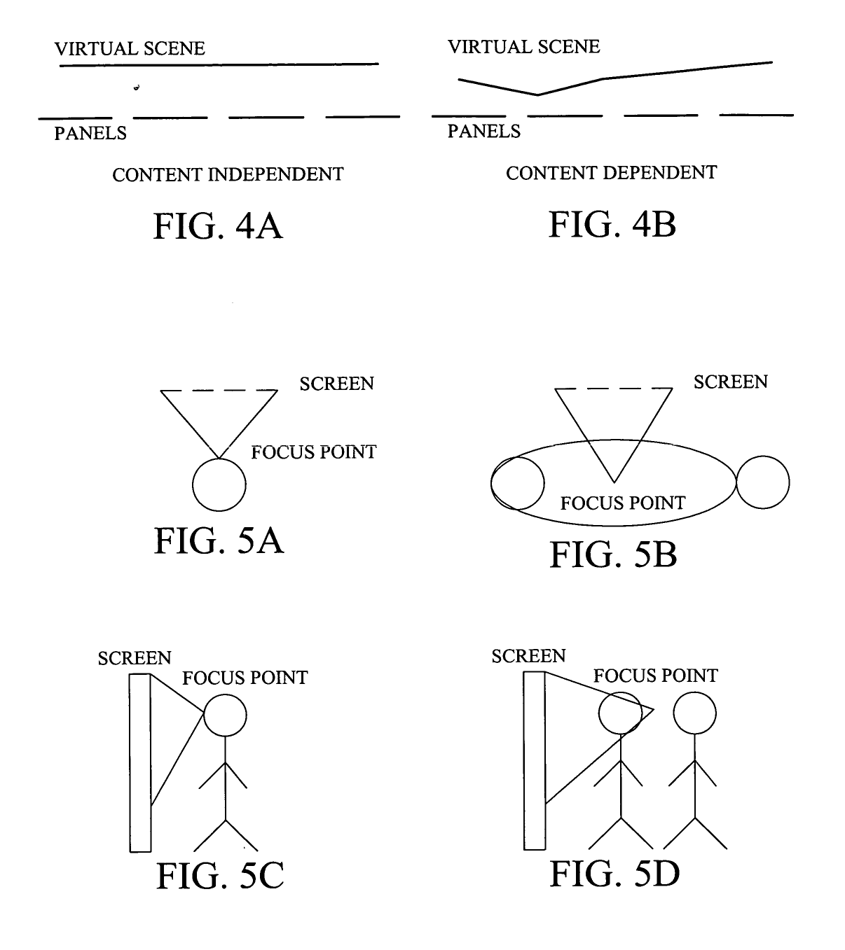

FIG. 4 graphically illustrates two examples of converting a 2D image to 3D structures. The left sub-figure is generated by content-independent conversion that simply attaches the 2D image to a planar surface behind the panels. In contrast, the right sub-figure demonstrates the result by content-dependent conversion, which consists of three different depth layers. When the viewers move their heads, they will observe motion parallax and varying image perspectives in the scene, which increase the sense of depth and immersion.

The converted 3D structure or original 3D content is further transformed in the 3D space so that it lies in the virtually visible area behind the panels and generates real-life appearances. Possible 3D transformations include scaling, translation, rotation, etc. For example, the virtual scene may be scaled such that the rendered human bodies are stretched to real-life sizes. After the transformation, the 3D structures are placed behind the panels and become ready for scene rendering.

After the virtual scene is created, the scene will be rendered for the viewer(s) in front of the display. In order to generate the sense of immersion and see-through experience, it is preferable to render the scene so that the light rays virtually emerging from the scene converge at the viewers' eyes. When the viewers move or otherwise the motion of the viewers are tracked, the scene is rendered to converge at the new eye positions in real time. In this manner, the viewers will feel that they are watching the outside world, while the panels serve as “virtual windows”.

As there may be more than one viewer in front of the display, it is not always preferred to make the scene converge at a single viewer. Instead, a 3D point, called focus point, may be defined as a virtual viewpoint in front of the display. All the optical rays are assumed to originate from the virtual scene and converge at the focus point, as shown in FIG. 5.

The focus point is estimated based on the eye positions of all (or a plurality of) the viewers. If there is a single viewer, this focus point may be defined as the center of the viewer's eyes (FIGS. 5(a) and 5(c)). If there are multiple viewers, the focus point may be determined by various techniques. One embodiment is to select the centroid of the 3D ellipsoid that contains the eye positions of all viewers, by assuming that all viewers are equally important, as shown in FIGS. 5(b) and 5(d). Another embodiment is to select the eye position of the viewer closest to the display as the focus point.

In the case of multiple viewers, the selected focus point may be deviated from the eye positions of one or more viewers. The display system will not be influenced by this deviation, as the display generates the see-through experience by rendering the same monocular view for both eyes. Consequently, the display system allows the viewers to move freely in front of the display without reducing the qualities of rendered scenes. In contrast, the stereoscopic displays generate binocular views for different eyes. The image quality of stereoscopic displays is largely influenced by how much the focus point is deviated from a number of pre-defined regions, called “sweet spots”.

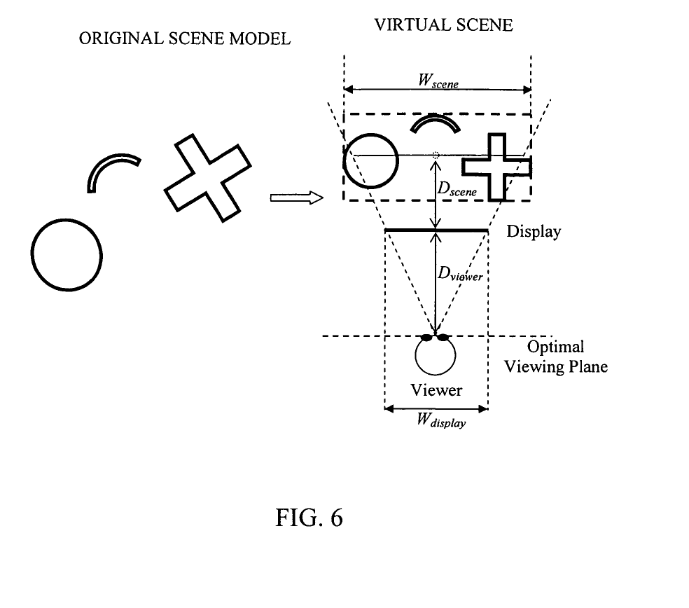

One example for transforming the virtual scene is illustrated in FIG. 6. Let W_{display} denote the width of the display screen and D_{viewer} as the optimal viewing distance in front of the display. The optimal viewing distance D_{viewer} is defined as the distance between the viewer and the center of the display. The optimal viewer-display distance is computed so that the viewers achieve the optimal viewing angle for the display, e.g., 30 degrees or more. If the viewing angle is 30 degrees, D_{viewer}∞1.866*W_{display}. This distance can also be increased or decreased based on viewer's preferences. Each distance corresponds to a vertical plane that is perpendicular to the ground plane and parallel to the display screen. The vertical plane that passes the viewer's eyes at the optimal distance is called optimal viewing plane. The viewers are expected to move around this plane in front of the display and do not deviate too much from the plane.

One parameter that may be adjusted is the distance between the center of the display screen to the center of the scene, so called scene-display distance, denoted by D_{scene} as shown in FIG. 6. The center of the scene can be selected as the center of a bounding box that contains all the geometric models within the scene. It can also be adjusted based on the viewer's height; that is, the center can be moved up when the viewer is taller and vice versa. The scene-display distance can be adjusted to generate different viewing experiences. If the scene-display distance is too small, the viewers cannot obtain a view of the entire scene and may observe strong perspective distortion. On the other hand, if the scene-display distance is too large, the scene is rendered in a small scale and does not provide a very realistic appearance.

A preferred embodiment of adjusting the scene-display distance is that the scene should be placed such that viewers can see most of the scene while there are still parts of the scene that cannot be seen at the first sight. The curiosity will drive the viewers to move around to see the whole scene. Through the movement in front of the display, the viewers can see more interesting parts of the scene and explore the unknown space behind the scene. This interactive process mimics the real-life experience of viewing the outside world through the windows and helps increase the sense of immersion.

As shown in FIG. 6, the viewer's field of view is extended towards the scene behind the display. The two extreme beams of eyesight that pass the display boundary define the boundary of the viewer's 3D visual cone. It is preferred that the visual cone contain only a portion of the scene, instead of the whole scene. Let W_{scene} denote the width of the bounding box of the scene. Then the scale of the scene may be adjusted so that

$$( 1 + \frac{{D}_{scene}}{{D}_{viewer}} ) {W}_{display} < {W}_{scene} < {KW}_{display}$$

The equation above shows that W_{scene} should be larger than W_{display}. However, as mentioned above, it is also useful to keep W_{scene} in a reasonable scale (K>1) compared to W_{display} so that the display does not become a small aperture to the scene. The value of K can be adjusted dynamically, if desired.

As shown in FIG. 2, the virtual scene may also be updated in the rendering process. Besides the elements that do not change over time, it may also contain dynamic elements that change over time. Examples include changing light sources in the scene, temporally updated image and video content, and moved positions of geometric models. In the embodiment of dynamic scene with live-feed information content previously described, new information content is also added to the scene when the viewers move to a new position or a new part of the scene is seen, creating an occlusion effect. For the other embodiment of free viewpoint scene, the video frame is updated at a high frequency (e.g., at least 30 frames per second) to generate real-time video watching experience. The scene update process may be implemented in a manner that it does not use too much processing power and does not block the scene rendering and viewer tracking process.

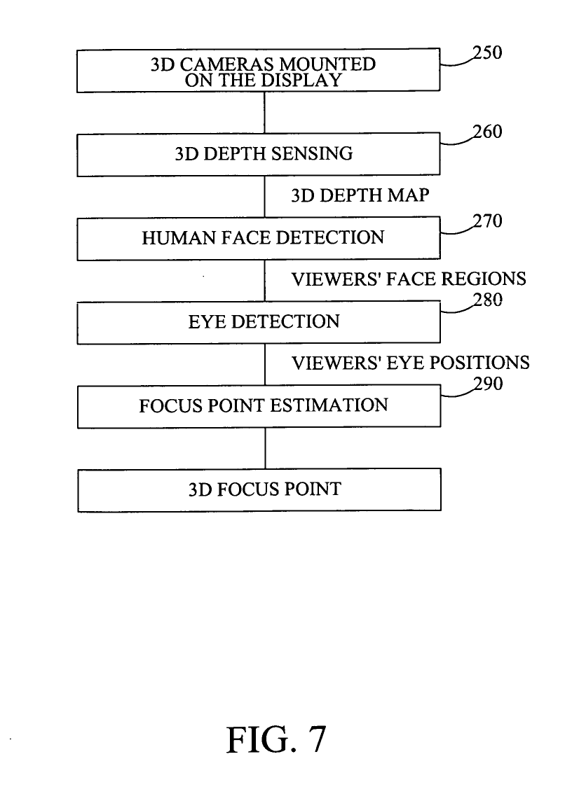

One exemplary process of tracking viewers and estimating focus point is shown in FIG. 7. One or more cameras 250 are mounted on the boundary of the display system (or integrated with the display) in order to track the viewers in 3D space. One embodiment utilizes a single 3D depth camera 260 that projects infra-red lights to the space in front of the display and measures the distance to the scene objects based on the reflected light. This depth camera is able to generate 3D depth maps in real time, and is not substantially influenced by the lighting conditions of the viewing environment.

Another embodiment utilizes a stereo pair of cameras to obtain the 3D depth map 260 in real time. The pair of cameras observes the scene from slightly different viewpoints. A depth map is computed by matching the image pairs captured from both cameras at the same time. The stereo camera pair typically generates more accurate depth map than 3D depth cameras, and yet is more likely to be influenced by the lighting conditions of the viewing environment.

Another embodiment utilizes 3D time-of-flight (TOF) depth cameras to observe and track the viewers in front of the display. The 3D TOF cameras are able to measure the 3D depth of human bodies directly. However, TOF cameras are generally limited by their relatively low image resolution (around 200 by 200 pixels) and relatively short sensing range (up to a few meters). Also the depth images generated by TOF cameras require high-complexity processing.

A preferred embodiment for viewer tracking is to utilize near-infra-red (IR) light sensitive cameras to track the viewers, such as OptiTrack cameras. The IR light cameras do not rely on the visible light sources and are sensitive to the infra-red lights reflected by the objects in the field of view. If the lights reflected by the objects tend to be weak, the camera may also use active IR lighting devices (e.g., IR LEDs) to project more lights into the scene and achieve better sensing performance.

The viewers are also asked to wear markers which are made of thin-paper adhesive materials. The markers have a high reflectance ratio of IR light so that the light reflected from the markers is much stronger than those reflected by other objects in the scene. The markers are not harmful to humans and can be easily attached and detached to viewers' skin, clothes, glasses, or hats. The markers can also be attached to small badges which are then clipped onto viewers' clothes as a non-intrusive ID. The markers are so thin and light that most viewers forget that they are wearing them. In addition, or alternatively, the system may include infra-red emitting light sources that are sensed.

As the dot patterns are much simpler than the human face and body appearance, they can be detected and tracked reliably at very high speed, e.g., up to 100 frames per second. Also, the tracking performance is not substantially influenced by the lighting conditions of the viewing environment. Even when the lights are turned off completely, the markers are still visibly seen by the IR camera (may be assisted by IR LEDs). Furthermore, the camera is primarily sensitive to the markers and does not need to capture images of human face and body for processing, which reduces potential consumer privacy concerns.

Multiple markers can be arranged into various dot patterns to represent different semantic meanings. For example, the markers can be placed into the patterns of Braille alphabets to represent numbers (0 to 9) and letters (A to Z). A subsection of Braille alphabets may be selected to uniquely represent numbers and letters even when the markers are moving and rotating due to viewers' motion. Different dot patterns can be used to indicate different parts of the human body or indicate different viewers in front of the display. For example, a number of viewers can wear different badges with Braille dot patterns, where each badge contains a unique pattern representing a number or a letter selected from the Braille alphabet. The dot patterns are recognized by standard pattern recognition techniques, such as structural matching.

Multiple markers (>=3) can be also organized in special geometric shapes (e.g. triangle) to form a 3D apparatus. One such apparatus may be markers on a baseball cap worn on the user's head. The distances between the markers may be fixed so that the camera can utilize the 3D structure of the apparatus for 3D tracking. Each camera observes multiple markers and tracks their 2D positions. The 2D positions from multiple views are then integrated for computation of the 3D position and orientation of the apparatus.

A number of concepts are first introduced to more clearly subsequently describe a viewer tracking scheme. First, the viewer's pose may be used to denote how the viewer is located in front of the display. The viewer's pose includes both position, which is the viewer's coordinates relative to the coordinate system origin, and orientation, which is a series of rotation angles between object axes to coordinate axes. More generally, the pose may be the position of the viewer with respect to the display and the angle of viewing with respect to the display. 2D and 3D positions of the viewer may be denoted by (x, y) and (X, Y, Z) respectively, while the object's 3D orientation is denoted by (θ_{X}, θ_{Y}, θ_{Z}). The viewer's 3D pose is useful for tracking process.

Second, the viewer's motion may be defined as the differences between viewer's 3D poses at two different time instants. The difference between viewer's 3D positions is called 3D translation (ΔX, ΔY, ΔZ), while the difference between viewer's 3D orientation is denoted by 3D rotation (Δθ_{X}, Δθ_{Y}, Δθ_{Z}). The 3D translation can be computed by subtracting the 3D position of one or more points. However, solving the 3D rotation includes finding the correspondences between at least three points. In other words, the rotation angles along three axes may be solved with three points at two time instants. Therefore, the 3D apparatus may be used if the 3D rotation parameters are desired.

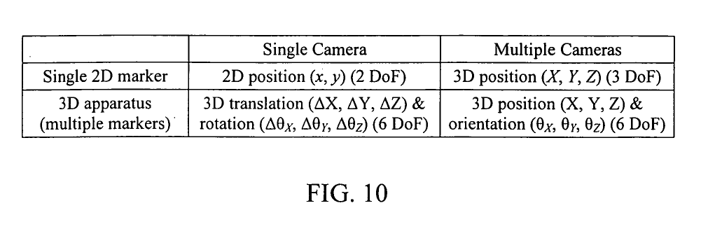

Third, the viewer's pose and motion may be classified into different categories by their degrees of freedom (DoF). If only the 2D location of a dot is available, the viewer's position is a 2-DoF pose and the viewer's 2D movement is a 2-DoF motion. Similar, the viewer's 3D position and translation are called 3-DoF pose and motion respectively. When both 3D position and orientation can be computed, the viewer's pose is a 6-DoF value denoted by (X, Y, Z, θ_{X}, θ_{Y}, θ_{Z}) and its motion is a 6-DoF value denoted by (ΔX, ΔY, ΔZ, Δθ_{X}, Δθ_{Y}, Δθ_{Z}). The 6-DoF results are most comprehensive representation of viewer's pose and motion in the 3D space. The 2D and 3D markers for single and multiple cameras is tabulated in FIG. 10.

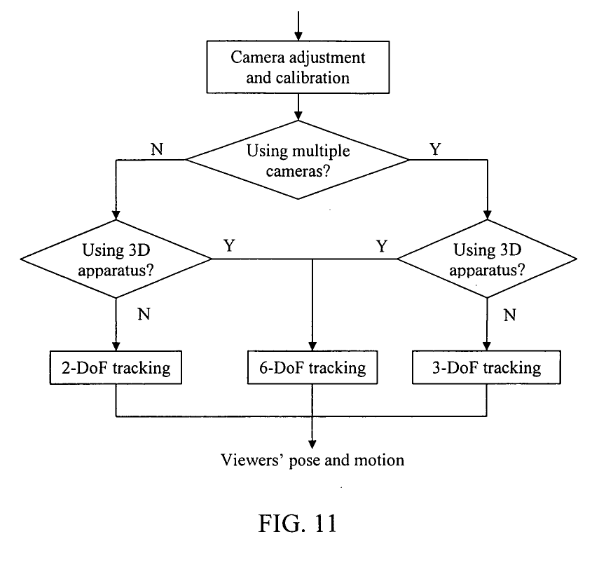

One example of a viewer tracking scheme is illustrated in FIG. 11. It starts by adjusting and calibrating the IR cameras, or other imaging devices. Other cameras may be used, as desired, as long as the marker points or other trackable feature may be tracked. The IR light cameras are adjusted to ensure that the patterns made of reflective markers are reliably tracked. The adjustment includes changing the camera exposure time and frame rate (which implicitly changes the shutter speed), and intensity of LED lights attached to the camera. The proper exposure time and LED light intensity helps increase the pixel value of the markers in the images captured by the camera.

The system may use one or multiple cameras. One advantage of multiple cameras over a single camera is that the field of view of multiple cameras is largely increased as compared to that of the single camera. One embodiment is to place the multiple cameras so that their optical axes will be parallel. This parallel camera configuration leads to a larger 3D capture volume and less accurate 3D position. Another embodiment is to place the cameras so that their optical axes intersect with one another. The intersecting camera configuration leads to a smaller 3D capture volume and yet can generate more accurate 3D position estimation. Either embodiment can be used depending on the environment and viewer's requirements. If multiple cameras are used, a 3D geometric calibration process may be used to ensure that the tracked 3D position is accurate.

Then different tracking methods are applied based on various configurations of cameras and markers, including 2-DoF tracking, 3-DoF tracking and 6-DoF tracking. It is of course preferred to allow 6-DoF tracking by using multiple cameras and 3D apparatus. However, if this is not feasible, 2-DoF and 3-DoF tracking methods may also be applied to enable the interactive scene rendering functionality.

Based on the configuration with one camera and one marker, only 2D position of the tracked dot, (x, y), is available, resulting in a 2-DoF tracking step. The 2D position of the marker worn by the viewer is updated constantly in real time (up to 100 frames per second). In this case, the viewer is assumed to be staying within the optimal viewing plane as described in FIG. 6, which fixes the Z coordinate of the viewer. More specifically, the 2D coordinate of the tracked point can be converted to 3D coordinate as follows: X=x, Y=y, Z⁼D_{viewer}. Whether the viewer is static or moving, the viewer's 2D position is constantly tracked and converted into a 3D viewing position.

When multiple cameras are used to track a single marker on the viewer, the viewer's 3D position is computed and updated, called 3-DoF tracking. The viewer's 3D position, (X, Y, Z), is computed by back-projecting optical rays extended from tracked 2D dots and finding their intersections in the 3D space. The computed 3D position is directly used as the viewer's position. Whether the viewer is static or moving, this 3-DoF tracking information may be obtained. The viewer's orientation, however, is not readily computed as there is only one marker.

When a 3D apparatus is used with one or more cameras, 6-DoF viewer tracking results can be computed. The difference between using one and multiple cameras is that, when only one camera is used, the 6-DoF result is generated as 3D translation and rotation between two consecutive frames. Therefore, if the viewer is not moving, the single camera cannot obtain the 6-DoF motion information. However, using multiple cameras allow tracking the viewer's 3D position and orientation even when the viewer is static. In either situation, the 6-DoF tracking result can be obtained.

Viewer's eye positions need to be estimated based on the tracked positions. One embodiment is to use the tracked positions as eye positions, since the difference between two points is usually small. Another embodiment is to detect viewers' eye positions in the original 2D image. The viewers' face regions 270 are extracted from the depth map by face detection techniques. Then the eye positions 280 are estimated by matching the central portion of human face regions with eye templates.

The focus point 290 is computed based on the eye positions of all viewers. Suppose there are N(>1) viewers in front of the display. Let Pᵢ denote the center of eye positions of the i-th viewer in the 3D space. Then the focus point, denoted by P₀, is computed from all the eye center positions. In a preferred embodiment, the focus point is determined as the centroid of all the eye centers as follows,

$${P}_{0} = \frac{1}{N} {\sum }_{i = 1}^{N} {P}_{i}$$

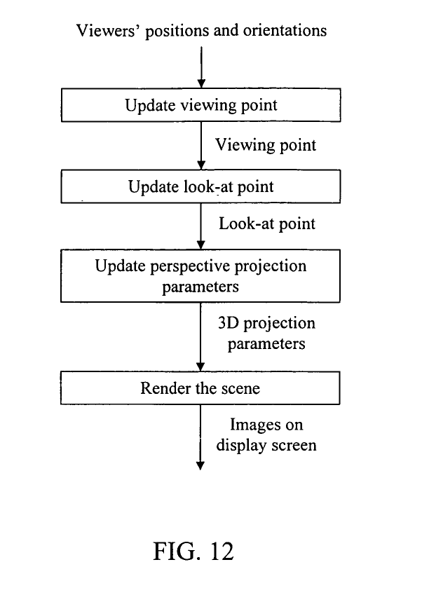

Referring to FIG. 12, a realistic scene rendering process takes the created virtual scene and tracked viewer positions as input and renders high-resolution images on the display screen. The rendering process may be implemented by a number of embodiments.

The preferred embodiment of rendering process is based on interactive ray tracing techniques. A large number of 3D optical rays are assumed to originate from the points in the virtual scene and converge at the focus point. The pixels on the panels are indeed the intersection of these rays with the flat panels.

The preferred ray tracing technique is described as follows. For a pixel on the flat panel, with its 2D coordinate denoted by p(u, v), its physical position in the 3D space, denoted by P(x, y, z), can be uniquely determined. The correspondence between 2D pixel coordinates and 3D point positions is made possible by geometric shape calibration of the panels. Then a 3D ray, denoted by \vec{PP₀}, is formed by connecting P₀ to P. This ray is projected from the virtual scene behind the panels towards the focus point P₀, through the point on the panel P. It is assumed that the optical ray is originated from a point in the 3D virtual scene, denoted by Pₓ. This scene point can be found by tracing back the optical ray until it intersects with the 3D geometric structures in the scene. This is why the process is called “ray tracing”.

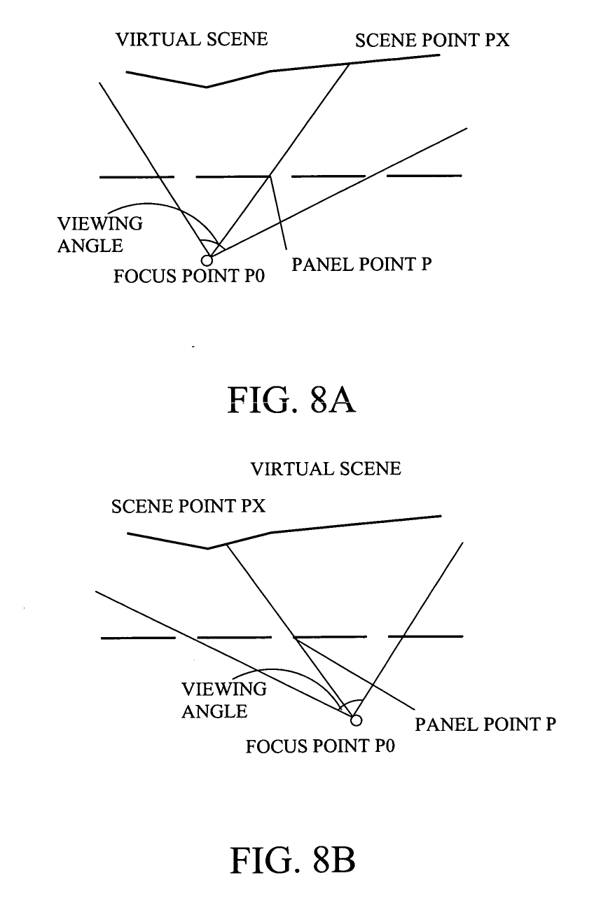

The scenario of ray tracing is illustrated in FIG. 8. Although only one ray is shown, the process generates a large number of rays for all the pixels on every panel. Each ray starts from the scene point Pₓ, passes through the panel point P, and converges at the focus point P₀. Once the focus point is changed to a new position, the rays are also changed to converge at the new position.

FIG. 8 illustrates, that when the focus point changes, the viewers will see different parts of scene and the rendered images will be changed accordingly. By comparing two sub-figures (a) and (b), one can observe that the scene structures seen by the viewers are different, even though the scene itself and display panels remain the same. In each sub-figure, the field of view is marked by two dashed lines and the viewing angle is indicated by a curve.

Besides observing different parts of the scene, the viewers will also see the relative motion between themselves and the scene when they move. With the panels as a static reference layer, the virtual scene appears to move behind the panels in the opposite direction to that of the viewer. Furthermore, the viewers will also observe the motion parallax induced by different depth layers in the 3D scene. If the depth layers are not parallel to the panels, viewers will also observe the changing perspective effects when they move. Also, the monocular view may be rendered in ultra-high image resolution, wide viewing angles, and real-life appearances. All these factors will greatly improve the see-through experiences and increase the sense of immersion and depth for the viewers.

Once the scene point is found by the ray tracing process, each pixel is assigned a color obtained by sampling the color or texture on the surface which the scene point lie on. One embodiment is to interpolate the color within a small surface patch around the scene point. Another embodiment is to average the color values of the adjacent scene points. The color values generated by the first embodiment tend to be more accurate than that by the second one. However, the second embodiment is more computationally efficient than the first one.

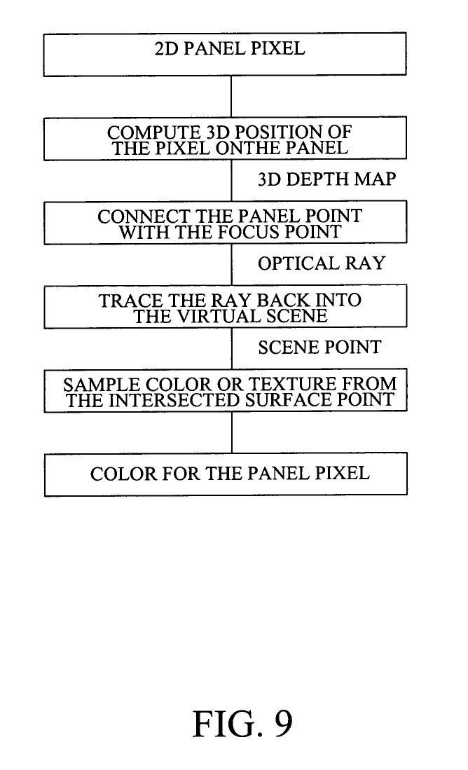

The overall ray tracing technique is summarized in FIG. 9. Although the pixel positions are different, the ray tracing process is the same and can be computed in parallel. Therefore, the ray tracing process for all pixels can be divided into independent sub-tasks for single pixels, executed by parallel processing units in the multi-core CPU and GPU clusters. In this manner, the rendering speed can be greatly accelerated for real-time interactive applications.

Another embodiment of the rendering process may utilize 3D perspective projection functionalities available from common 3D graphics engines including OpenGL, Microsoft Direct3D, and Mesa to render and update the 2D images on the display screen. The rendering process starts by determining two points, namely a viewing point and a look-at point, as used by 3D graphics engines. In general, any suitable input to the graphics card may be used, such as data indicating where the viewer is and data indicating the viewer's orientation with respect to the display. Then the graphics engine converts the two points into a perspective projection parameter matrix and generate 2D rendering of the virtual 3D scene.

In order to generate an immersive see-through experience, the graphics rendering engines determine two points in the 3D space. The first point, called the viewing point, is where the viewers stand in front of the display, which is the focus point in the first embodiment of the rendering process. The second point, called look-at point, is the point where the viewers look at. With the two points, the rendering engines can decide the virtual field of view and draw the scene in correct perspectives so that the viewers feel as if the scene converges towards them.

If there is only one viewer in front of the display, the viewing point is the viewer's position. However, if there is more than one viewer in front of the display, the viewing point may be selected from multiple viewers' positions, as previously described.

The look-at point is decided in a different manner. In the traditional virtual reality (VR) applications, the look-at point is defined as a certain point in the scene, e.g., the center of the scene. However, in this see-through window application, the look-at point may be defined as a point on the display. One embodiment is to define the center of the display as the fixed look-at point. A preferred embodiment is to define the look-at point as a point moving in a small region close to the center of the display according to the viewer's motion.

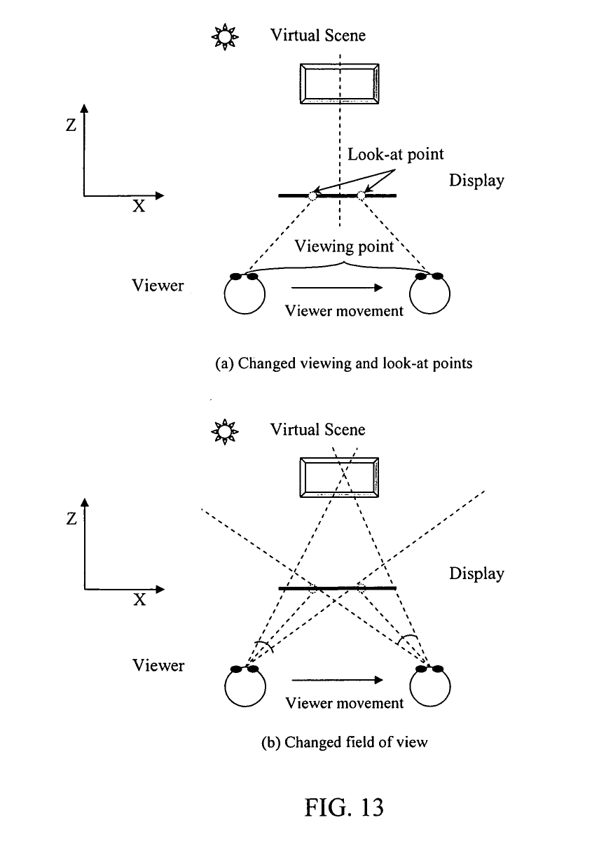

As shown in FIG. 13(a), when the viewer moves to different positions in front of the display, the look-at point also moves along the display screen and reacts to the viewer's motion. The movement of look-at point can be computed as proportional to the movement of the viewer's motion, as shown in the following equations:

ΔXₗₒₒₖ₋ₐₜ=α_{X}*ΔX_{viewer}, ΔYₗₒₒₖ₋ₐₜ=α_{Y}*ΔY_{viewer}

Where α_{X} and α_{Y} are pre-defined coefficients and can be adjusted for different display sizes.

The main difference between the see-through window and the traditional virtual reality (VR) rendering is that when the viewer moves, the VR rendering programs usually change the look-at position in the scene along the same direction. For example, in the traditional VR mode, when the viewer moves to the right side of the screen, the scene also moves to the right, that is, more right side of the scene becomes visible. In the implementation of see-through window, however, the look-at point results in an inverse effect. When the viewer moves to the right side of the screen, the scene moves to the left, that is, more left side of the scene becomes visible. Indeed, this effect utilizes an important factor in visual perception, namely occlusion. Occlusion refers to the effect that a moving viewer can see different parts of the scene which are not previously seen by the viewer. This is consistent with our real-life experience that when people move in front of a window, they will see previously occluded parts of the scene, as illustrated in FIG. 13(b). The see-through window application simulates the occlusion created by virtual windows and triggers the viewers to feel that the display screen is indeed a virtual window to the outside world.

Furthermore, the determination of look-at point helps generate another visual cue, namely, motion parallax. Motion parallax refers to the fact that the object at different depth layers move in different speeds relative to a moving viewer. As the look-at point is fixed on the display screen, all the objects in the scene lie behind the display screen and move at different speeds when the viewer moves. A moving viewer will observe stronger motion parallax as he moves in front of the display than the case where the look-at point is selected within the scene.

The graphics rendering engines also may use additional parameters to determine the perspective projection parameters, besides the two points. For example, the viewing angle or field of view (FoV) in both horizontal and vertical directions can also change the perspectives. One embodiment is to fix the FoV so that it fits the physical configuration of the display and does not change when the viewer moves, partly because the viewer is usually far away from the virtual scene. Another embodiment is to adjust the FoV in small amounts so that when the viewer gets closer to the display, the FoV increases and the viewer can see a wider portion of the scene. Similarly, when the viewer moves further from the display, the FoV decreases and a narrower portion of the scene can be seen.

Another difference between the see-through window and the traditional VR applications is that the viewer's 3D rotation does not introduce much change in the perspectives. The real-life experiences show that when the viewer rotates his head in front of a window, the scene visible through the window does not change. Also the viewer's eye will automatically compensate for the viewer movement and focus on the center of the window. This is also true for the viewer-display scenario. Therefore, the viewer's 3D rotation is intentionally suppressed and only introduces small change to the perspective projection parameters. The amount of change can be also adjusted by the viewers for their preferences.

All these parameters, including the viewing point, look-at point, and field of view, may be updated in real-time to reflect the viewer's position in front of the display. Various monocular visual cues, including occlusion and motion parallax, may also be utilized to increase the realism of the rendered scene and the sense of immersion. The viewers will observe a realistic scene that is responsive to his or her movement and is only limited by the display which serves as virtual windows.

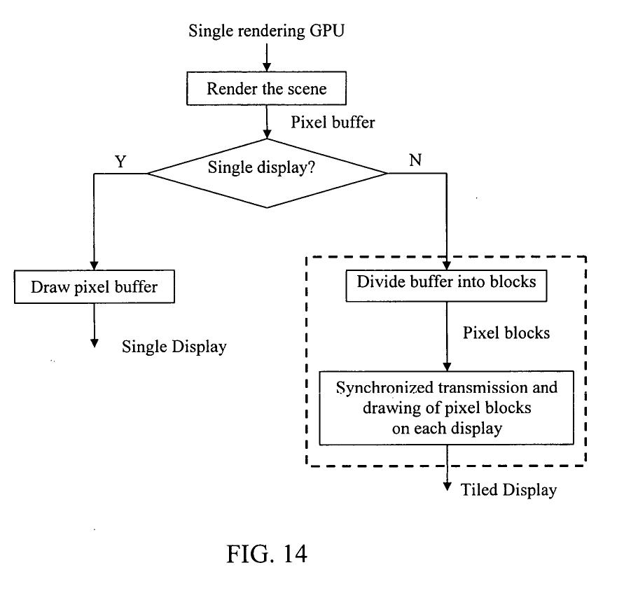

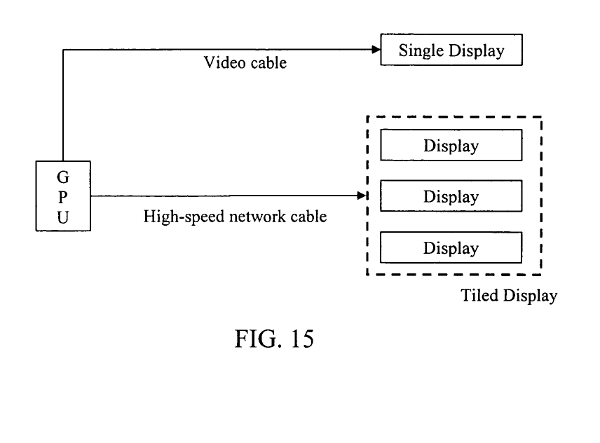

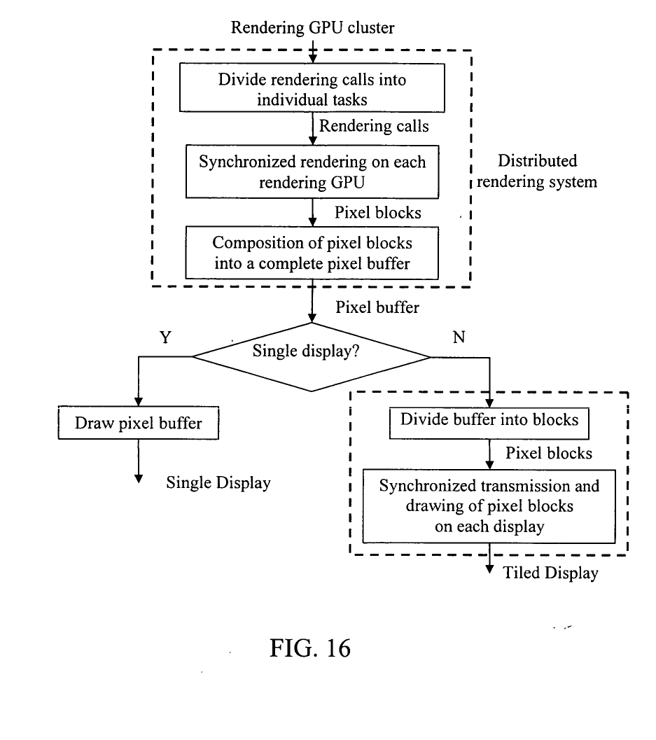

The rendering process for the see-through window can be implemented on various configurations of rendering and display systems, as shown in FIGS. 14-19. The rendering system may use a single GPU device, including graphics cards in desktop and laptop PCs, special-purpose graphics board (e.g., nVidia Quadro Plex), cell processors, or other graphics rendering hardware (FIGS. 14 and 15). The rendering system may also be a distributed rendering system that utilizes multiple GPUs which are inter-connected through PC bus or networks (FIGS. 16-19). The display system may consist of a single large display or tiled display that is connected through video cables or local networks.

One embodiment of rendering-display configurations, as shown in FIGS. 14 and 15, is to render the scene on a single GPU with a graphics card, resulting in a pixel buffer with high-resolution (e.g., 1920×1080) images at high frame rates (e.g., 30 fps). The pixel buffer is then displayed on a single or tiled display. In the case of tiled display, the original pixel buffer is divided into multiple blocks. Each pixel block is transmitted to the corresponding display and drawn on the screen. The transmission and drawing of pixel blocks are controlled by either hardware-based synchronization mechanisms or synchronization software.

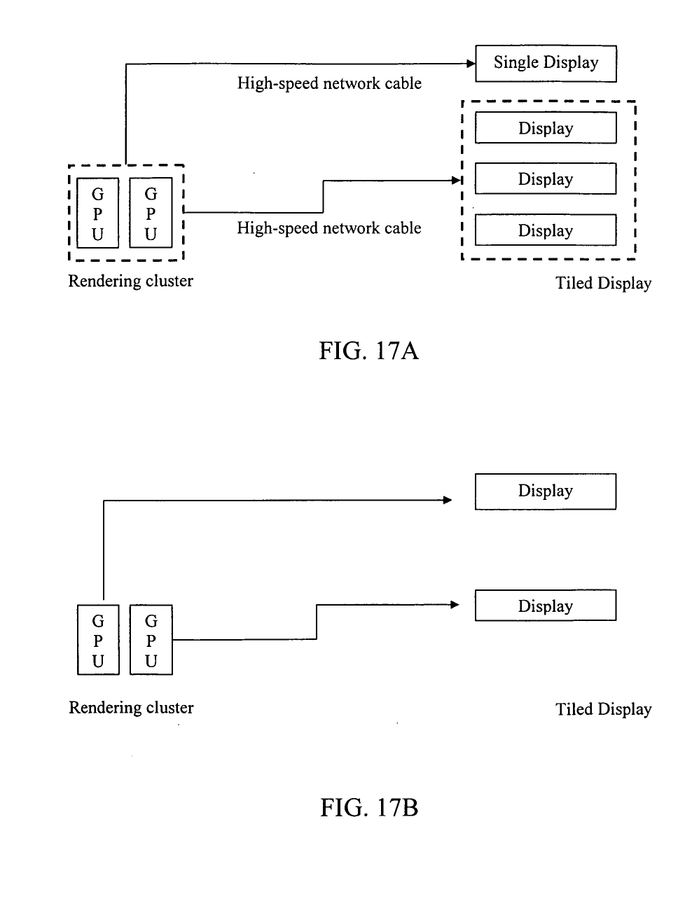

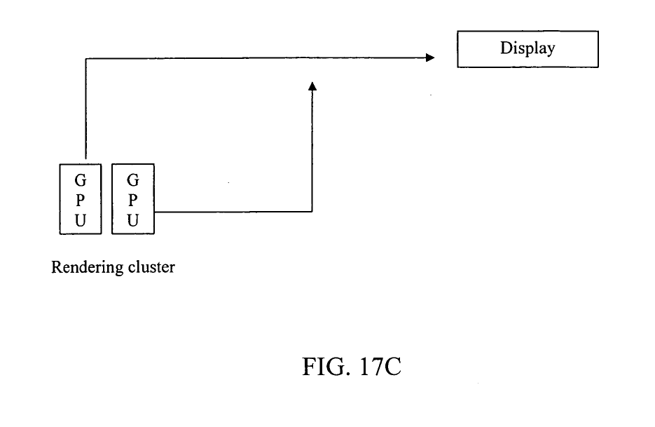

Another embodiment of render-display configurations, as shown in FIGS. 16 and 17, is to run the rendering task on a distributed rendering system and display the scene on a single or tiled display. The rendering task, consisting of a series of rendering calls, is divided into multiple individual tasks and sent to individual GPUs. The pixel block generated by each GPU is then composed to form the whole pixel buffer. Then the pixel buffer is sent to a single or tiled display.

The embodiments shown in FIGS. 14-17 use a high-speed network to connect the rendering system and tiled display system, as the pixel buffer contains high-resolution images and is sent through the network at high frame rates. Furthermore, the pixel buffer may not reach the native resolution of the displays if limited by the available bandwidth. The generated pixel buffer may be further scaled up to be drawn on the display.

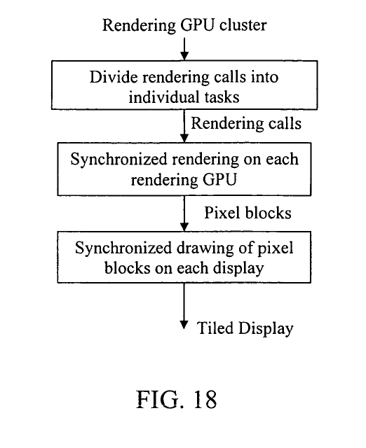

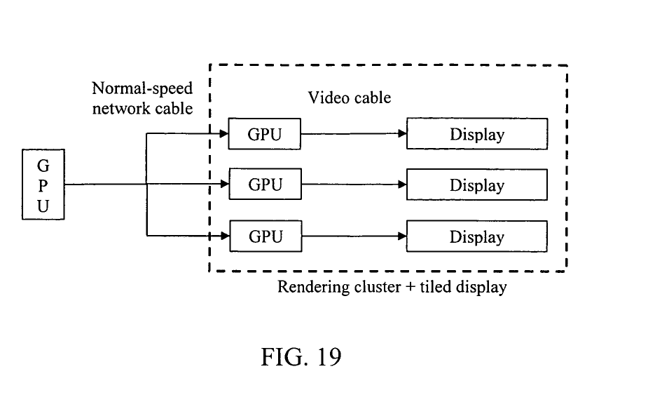

A preferred embodiment for the tiled display, as shown in FIGS. 18 and 19, is to combine the distributed rendering system and the tiled display system together. The combined system divides the rendering calls into individual tasks and send the tasks to the GPUs. The rendering tasks completed at the GPUs are directly drawn on the displays. This embodiment does not need high-speed network as the rendering calls take much less bandwidth as compared to the pixel buffer. It utilizes the GPU-display couples to render ultra-high-resolution scenes in very high frame rates without scaling the image. The theoretical image resolution is only limited by the number of pixels available in the tiled display.

The processing may use the initial GPU to do the processing to render the entire image on the display. The different parts of the rendered image are sent to the respective parallel GPUs which then do not render the image, but rather use the GPU merely to display the image on the associated display. An alternative technique is the initial GPU may simply break up the image into a set of different images that are forwarded to the parallel GPUs for rendering. In this manner, the local parallel GPUs may do the rendering on merely a part of the total image, which may reduce the overall computational power required for a single GPU to render the entire image.

Due to the high cost of large-size flat panels, it is more economic to integrate an array of smaller panels to build a tiled display system for generating the same see-through experience. Conventional tiled display system requires all the flat panels to be aligned in a single plane. In this planar configuration, the visual media is physically attached to each flat panel, and is therefore restricted in this plane. When a panel is moved or rotated, the view of the whole display is distorted. Furthermore, the conventional tiled display systems apply the same display parameters (e.g. brightness and color) to all the panels. If the display setting of one panel is changed, the whole view is also disturbed.

The scene rendering process allows the separation between the scene and the flat panels. Therefore, there exists considerable flexibility in the configuration of the panels, while the rendered see-through experience is not affected or even improved. Although the shape of each panel cannot be changed, the geometric shapes of the whole tiled display can be changed by moving and rotating the panels. The display parameters, including brightness and color, can be changed for each panel independently. The flexibility in geometric shapes and display parameters enables the tiled display system to adapt to different viewing environments, viewers' movements and controls, and different kinds of visual media. This flexibility is also one of the advantages of the tile display over a single large panel. Such flexibility could also be offered by single or multiple unit flexible displays.

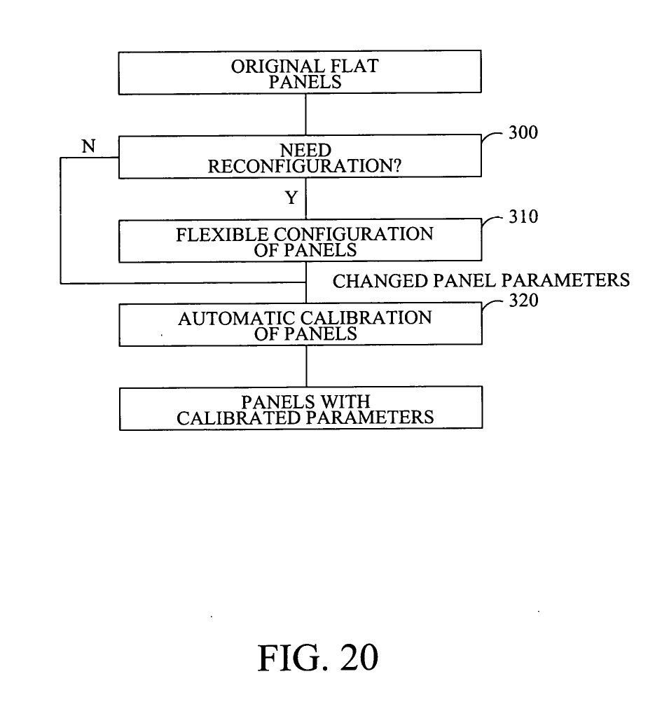

The geometric shapes and display parameters changed by the configuration are compensated for by an automatic calibration process, so that the rendering of virtual see-through scenes is not affected. This panel configuration and calibration process is illustrated in FIG. 20. If a panel re-configuration is needed 300, the geometric shape and display parameters of the tiled display have changed 310. Then an automatic calibration process 320 is executed to correct the changed parameters. This calibration process takes only a short time to execute and is performed only once, after a new panel configuration is done.

Although the flat shape of each panel is not readily changed, the tiled display can be configured in various geometric shapes by moving and rotating the panels. Besides the traditional planar shape, different shapes can allow the tiled display to adapt to different viewing environments, various kinds of visual media, and viewers' movements and control.

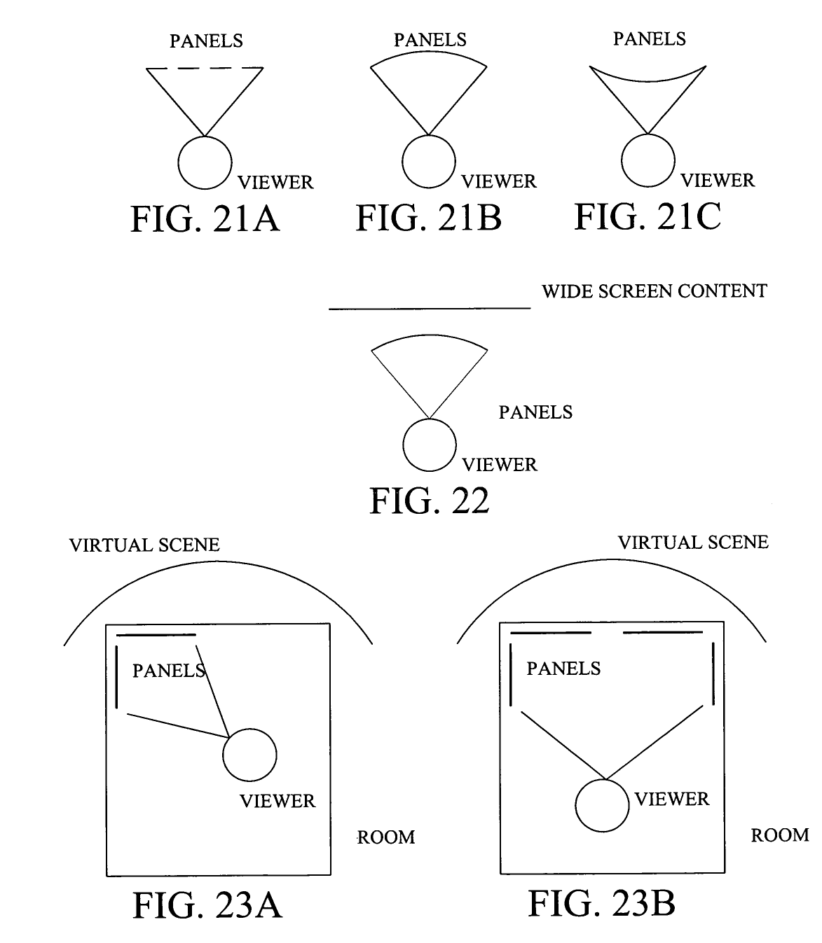

As shown in FIG. 21, the tiled display can be configured in a traditional flat (in (FIG. 21a)), concave (in FIG. 21(b)), or convex shape (in FIG. 21(c)). In the case of curved (concave or convex) shapes, more panels pixels are needed to cover the same field of view. In other words, the tiled display in curved shapes requires either adding more panels or increasing the size of each panel. For the same field of view, the tiled display in curved shapes can render more visual media due to the increased number of pixels, as shown in (b) and (c).

One direct application of the curved shapes is to render the wide-screen images or videos on the tiled display without resizing the image. In the context of frame format conversion, resizing the image from a wider format to a narrower format, or vice versa, will introduce distortion and artifacts to the images, and also require much computation power. Due to the separation between the panels and the scene behind them, scene rendering is done by the same ray tracing process, without resizing the images. Furthermore, as the viewers get closer to the image boundaries, they may gain a stronger sense of immersion.

FIG. 22 shows the scenario of rendering wide-screen content on a concave shaped tiled display, where the wide-screen content is placed behind the panels. The aspect ratio of rendered images is increased by the concave shape, e.g. from the normal-screen 4:3 (or equivalently 12:9) to the wide-screen 16:9. Depending on the aspect ratio of the content, the tiled display can be re-configured to various concave shapes. For example, the curvature of the display can be increased in order to show the wide-screen films in the 2.35:1 format.

The geometric shape of tiled display can be also re-configured to fit the viewing environment. The extreme cases are that the tiled display is placed in a room corner between different walls. FIG. 23 shows that the tiled display is placed in an “L” shape around a room corner in (a) and in a “U” shape across three walls in (b), with the angles between panels being 90 degrees. The display is better fitted to the viewing environment and reduces the occupied space. Furthermore, this shape also helps increase the sense of immersion and 3D depth. Furthermore, additional panels can be added to the tile while existing panels can be removed, followed by the calibration step.

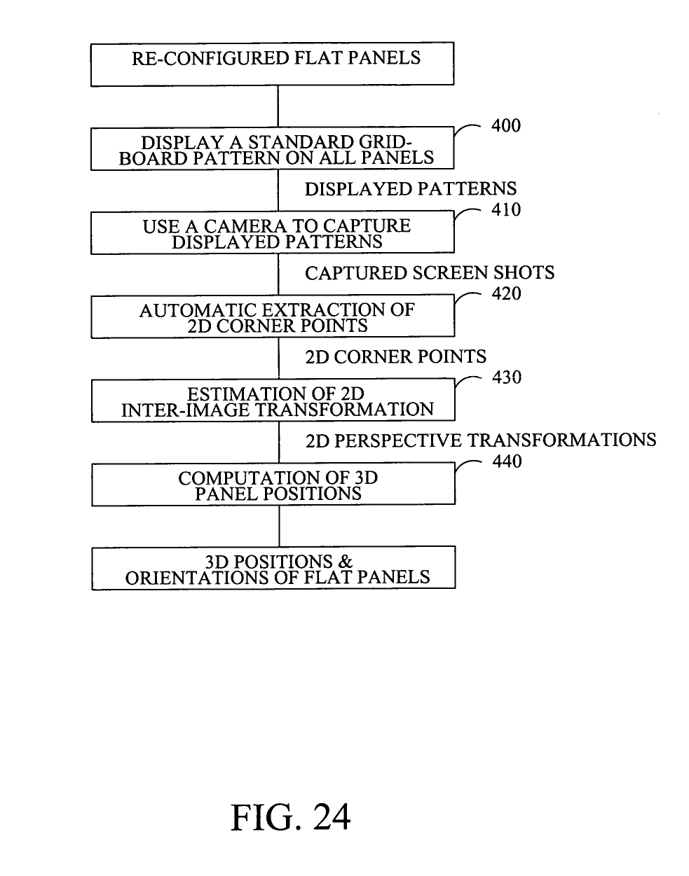

The goal of calibration is to estimate the position and orientation of each panel in the 3D space, which are used by the scene creation and rendering process. A preferred embodiment of the geometric calibration process utilizes a calibration process that employs one camera in front of the display to observe all the panels. For better viewing experience, the camera can be placed in the focus point if it is known. The calibration method is illustrated in FIG. 24. First, a standard grid pattern, e.g. checkerboard, is displayed on each flat panel 400. Then the camera captures the displayed pattern images from all the panels 410. In each captured image, a number of corner points on the grid pattern are automatically extracted 420 and corresponded across panels. As the corners points are assumed to correspond to the 3D points lying on the same planar surface in 3D space, there exists a 2D perspective transformation that relates these corner points projected on different panels 420. The 2D inter-image transformation, namely perspective transformation, can be computed between any pair of panels from at least four pairs of corner points. The 3D positions and orientation of panels 440 are then estimated based on the set of 2D perspective transformations.

As each flat panel has its own independent display settings, there exists significant flexibility in the display parameters of the tiled display. The display parameters include, for example, the maximum brightness level, contrast ratio, gamma correction, and so on. As the viewers may freely change the geometric shapes and display settings of the tiled display, the displayed parameters need to be calibrated to generate the same see-through experience.

The tiled display in the traditional planar shape can be calibrated relatively easily. All the flat panels can be reset to the same default display setting which may complete the calibration task for most cases. If there still exists inconsistency in the brightness, contrast, colors, and so on between the panels, calibration methods are applied to correct these display parameters.

For the tiled display in non-planar shapes, however, the calibration of display parameters becomes more difficult. It is known that the displayed colors on the panels will be perceived differently by the viewers from a different viewing angle, due to the limitations of manufacturing and displaying techniques for flat panels. This is known as the effect of different viewing angles on the display tone scale. The case of using multiple panels is more complicated. As the panels may not lie in the same plane, the relative viewing angles between the viewers and each panel may always be different. Even if the display setting of every panel is the same, the perceived colors on different panels are not consistent. In other words, the tiled display in non-planar shapes is very likely to generate inconsistent colors if no calibration of display parameters is done. Therefore, the calibration of the display parameters becomes ultimately necessary for the tiled display in non-planar shapes.

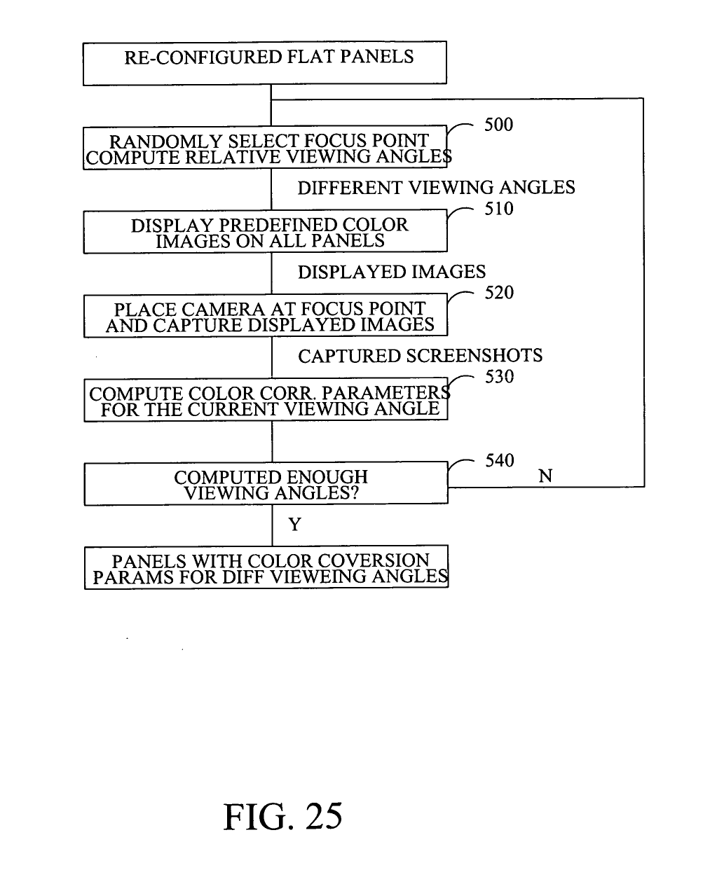

A preferred embodiment of display parameter calibration focuses particularly on correcting the colors displayed on the tiled display from different viewing angles, as shown in FIG. 25. The color correction method aims at compensating for the difference in the color perception due to different geometric shapes of the tiled display. Instead of making physical modification to the panels, the calibration process generates a set of color correction parameters for each panel, which can easily be applied to the rendered image in real time.

A focus point is defined as the virtual viewpoint for all the viewers in front of the display. When the viewers move, this focus point also changes. The relative viewing angle between the eye sights started from the focus point and each panel is computed. In order to allow the viewers to move freely in the 3D space in front of the display, the calibration process randomly selects a large number of focus points 500 in front of the display and applies the same color correction method to each of these points.

A color correction method, similarly to the one described in FIG. 25, is applied for panel calibration. First, a predefined color testing image 510 is displayed on each panel. The color testing image may contain multiple color bars, texture regions, text area, and other patterns. A camera 520 is placed in the focus point to capture the displayed images. Then the color characteristics 530, such as gamma curves, are computed from both the predefined image and the captured image. The difference between color characteristics are corrected by a number of color correction parameters, including a color look-up table and the coefficients of color conversion matrices. These color correction parameters are specifically determined for the current relative viewing angle for each panel.

The same color correction technique is repeated 540 with randomly selected focus points until enough viewing angles have been tested for each panel. Then each panel stores a set of color conversion parameters, each of which is computed for a specific viewing angle. The panels can determine the color conversion parameters according to the relative viewing angle and correct the color images in real time. The viewers can move freely in front of the display and observe the rendered scenes with consistent colors.

The system may include an interface which permits the viewer to select among a variety of different configurations. The interface may select from among a plurality of different 2D and 3D input sources. The interface may select the maximum numbers of viewers that the system will track, such as 1 viewer, 2 viewers, 3 viewers, 4+ viewers. The configuration of the display may be selected, such as 1 display, a tiled display, whether the display or a related computer will do the rendering, and the number of available personal computers for processing. In this manner, the computational resources may be reduced, as desired.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A method for displaying an image on a display comprising:
(a) providing said display for displaying an image thereon;
(b) providing a three dimensional representation of an image;
(c) rendering said three dimensional representation as a two dimensional representation on said display;
(d) providing an imaging device associated with said display;
(e) determining the location and the orientation of viewing of a viewer with respect to said display;
(f) modifying said rendering on said display based upon said determining the location of said viewer with respect to said display.

2. The method of claim 1 wherein said modifying results in said viewer observing two dimensional motion parallax.

3. The method of claim 1 wherein said location includes the viewer's head position.

4. The method of claim 1 wherein said location includes the viewer's eye position.

5. The method of claim 1 further comprising providing a plurality of imaging devices associated with said display used for said determining.

6. The method of claim 4 wherein said orientation includes the location of a gaze of said viewer.

7. The method of claim 1 wherein said three dimensional representation is generated from the input of a two dimensional representation.

8. The method of claim 7 wherein said three dimensional representation is created from said two dimensional representation based upon a visual media content independent technique.

9. The method of claim 7 wherein said three dimensional representation is created from said two dimensional representation based upon a visual media content dependent technique.

10. The method of claim 1 wherein said modifying is based upon the viewer's head position.

11. The method of claim 1 wherein said rendering is based upon the convergence of a plurality of optical rays.

12. The method of claim 1 wherein said three dimensional image is based upon receiving a two dimensional image.

13. The method of claim 12 wherein said two dimensional image is at least one of a video, a text, a vector graphic, a drawing.

14. The method of claim 13 wherein said three dimensional image is at least one of graphics, scientific data, and a gaming environment.

15. The method of claim 14 wherein said three dimensional image includes at least one of a structure including points, a surface, a solid object, a planar surface, a cylindrical surface, a spherical surface, a surface described by a parametric equation, and a surface described by a non-parametric equation.

16. The method of claim 1 wherein said rendering is modified based upon a viewer's field of view.

17. The method of claim 15 wherein said three dimensional image is rendered by a graphics processing unit.

18. The method of claim 1 wherein said three dimensional representation further includes live feed information content.

19. The method of claim 1 wherein said three dimensional representation further includes free viewpoint video.

20. The method of claim 1 wherein the color and luminance of said two dimensional representation is based upon the color and luminance of said three dimensional representation.

21. The display of claim 1 wherein said display is flat.

22. The display of claim 1 wherein said display is not flat.

23. The display of claim 1 wherein said display includes a plurality of panels.

24. The display of claim 23 wherein each of said plurality of panels are flat.

25. The display of claim 1 wherein the color of said two dimensional representation is based upon tracing optical rays into said three dimensional representation and sampling colors from said three dimensional representation.

26. The display of claim 1 wherein said display includes a plurality of panels and each of said panels are calibrated.

27. The display of claim 26 wherein said calibration for each of said panels is independent of another of said panels.

28. The display of claim 26 wherein said calibration includes brightness and color.

29. The display of claim 23 wherein said panels are at an angle between zero and 180 degrees with respect to one another.

30. The display of claim 1 wherein said determining said location is based upon a plurality of viewers.

31. The display of claim 1 wherein said display is concave.

32. The display of claim 1 wherein said display is convex.

33. The display of claim 1 wherein said imaging device includes an infra-red imaging device.

34. The display of claim 33 further comprising said imaging device sensing at least one of primarily infra-red reflecting markers and infra-red emitting lights.

35. The display of claim 34 wherein said imaging device includes an infra-red lighting device.

36. The display of claim 34 further comprising interpreting a pattern of sensed infra-red reflecting markers.

37. The display of claim 36 wherein said pattern is representative of an alphanumeric character.

38. The display of claim 36 wherein said pattern is representative of a distance.

39. The display of claim 38 wherein said distance is used for tracking.

40. The display of claim 1 further comprising tracking a movement of said viewer.

41. The display of claim 40 wherein said tracking includes 3D translation.

42. The display of claim 40 wherein said tracking includes 3D rotation.

43. The display of claim 40 wherein said movement has 3 degrees of freedom.

44. The display of claim 40 wherein said movement has 2 degrees of freedom.

45. The display of claim 40 wherein said movement has 6 degrees of freedom.

46. The display of claim 1 wherein said rendering is based upon a viewing point and a look at point.

47. The display of claim 46 wherein when said look at point moves one direction the scene moves in the opposite direction.

48. The display of claim 46 wherein said display includes motion parallax.

49. The display of claim 46 wherein said rendering is based upon perspective projection parameters.

50. The display of claim 1 wherein said rendering is performed in a single graphics processing unit.

51. The display of claim 1 wherein said rendering is performed by a plurality of graphics processing units.

52. The display of claim 50 wherein said rendered image is displayed on a single display.

53. The display of claim 50 wherein said rendered image is displayed on a plurality of displays.

54. The display of claim 53 wherein each of said plurality of displays includes an associated graphics processing unit that does not render said image.

55. The display of claim 51 wherein said rendered image is displayed on a single display.

56. The display of claim 51 wherein said rendered image is displayed on a plurality of displays.

57. The display of claim 56 wherein each of said plurality of displays includes an associated graphics processing unit that does not render said image.

58. The display of claim 34 wherein a viewer is tracked when the viewer is wearing a marker.

59. The display of claim 34 wherein a viewer is tracked when the viewer is wearing multiple markers.

60. The display of claim 40 wherein said movement is determined based upon temporal filtering.

61. The display of claim 60 wherein said filtering includes a Kalman filter.

62. The display of claim 1 wherein said rendering is based upon a viewing point that moves in the same direction as that of the viewer's movement.

63. The display of claim 1 wherein said rendering results in a different view of view based upon viewer movement.

64. The display of claim 48 wherein said motion parallax is based upon sensing viewer movement.
